(19) United States
(12) Patent Application Publication
(10) Pub. No.: US 2018/0172808 A1
(43) Pub. Date: Jun. 21, 2018

(54) OBJECT DETECTION DEVICE

(71) Applicants: Naoki Otani, Aichi (JP); Daisuke Itao, Aichi (JP); Motomu Yokota, Aichi (JP); Hoshibumi Ichiyanagi, Aichi (JP)

(72) Inventors: Naoki Otani, Aichi (JP); Daisuke Itao, Aichi (JP); Motomu Yokota, Aichi (JP); Hoshibumi Ichiyanagi, Aichi (JP)

(73) Assignee: OMRON AUTOMOTIVE ELECTRONICS CO., LTD., Aichi (JP)

(21) Appl. No.: 15/849,380

(22) Filed: Dec. 20, 2017

(30) Foreign Application Priority Data
Dec. 20, 2016 (JP) 2016-246601

(51) Int. Cl. G01S 7/497; G01S 17/08; G01S 7/481

(52) U.S. Cl. CPC G01S 7/497; G01S 7/4818; G01S 7/4817; G01S 17/08

(57) ABSTRACT

An object detection device includes: a light emitter; a light receiver; a rotating scanner having a mirror and reflecting light from the light emitter off the mirror by rotating the mirror to scan the reflected light over a predetermined range, and reflecting light reflected off a target off the mirror to guide the reflected light to the light receiver; an object detector detecting whether there is a target, based on a light reception signal; a light guider guiding light from the light emitter to the light receiver; and a failure detector detecting whether there is a failure, based on a light emission state of the light emitter and a light reception state by the light receiver. The light guider receives light emitted from the light emitter and reflected off the mirror, and reflects the light off the mirror to guide the reflected light to the light receiver.

### CROSS-REFERENCE TO RELATED APPLICATION

This application is based on Japanese Patent Application No. 2016-246601 filed with the Japan Patent Office on Dec. 20, 2016, the entire contents of which are incorporated herein by reference.

### FIELD

The disclosure relates to an object detection device that detects a target by projecting and receiving light, and more particularly to self-diagnosis of a failure in an optical system.

### BACKGROUND

An object detection device such as a laser radar for vehicle mounting projects light from a light emitter over a predetermined range and detects whether there is a target, based on a result of reflected light of the projected light that is received by a light receiver (e.g., JP 2002-31685 A, JP 2010-204015 A, JP H10-31064 A, JP 2014-145744 A, and WO 2016/012579 A). In addition, there is also an object detection device that detects a distance from the object detection device to a target, based on a period of time from when a light emitter emits light until a light receiver receives light reflected off the target (e.g., JP 2012-93256 A and JP H09-318736 A).

For the light emitter, light emitting elements such as laser diodes are used. For the light receiver, light receiving elements such as photodiodes are used. In JP 2002-31685 A, JP 2010-204015 A, JP 2014-145744 A, and WO 2016/012579 A, a rotating scanner is provided to project and receive light over/from a wide range and to miniaturize the object detection device.

Hence, light projected from the light emitter passes through optical components of a light projection system such as a light projecting lens and a mirror, and then is reflected off a rotatable mirror included in the rotating scanner, and a target is irradiated with the reflected light. At this time, by the rotation of the mirror of the rotating scanner, the light from the light emitter is deflected by the mirror and scanned over a predetermined range where a target is to be detected. Then, light reflected off the target is reflected off the mirror of the rotating scanner. The reflected light passes through optical components of a light reception system such as a mirror and a light receiving lens, and then is received by the light receiver. At this time, too, by the rotation of the mirror of the rotating scanner, the light reflected off the target present in the predetermined range is deflected by the mirror and guided to the optical components of the light reception system and the light receiver. Note that, in JP 2002-31685 A, the light reflected off the target is received by the light receiver without passing through the rotating scanner.

If an optical system has a failure, then it is not possible to accurately detect whether there is a target or detect a distance from the optical detection device to the target. In view of this, there is proposed a function of self-diagnosing a failure in the optical system in the object detection device.

For example, in JP 2002-31685 A, JP H09-318736 A, and JP H10-31064 A, a light guider provided in the object detection device guides light from the light emitter to the light receiver. Specifically, in JP 2002-31685 A, a portion of light that is emitted from the light emitter and reflected off the mirror of the rotating scanner is reflected off a transparent window plate through an optical path for self-diagnosis provided inside a case, to guide the reflected light to the light receiver. In JP H09-318736 A, a portion of light emitted from the light emitter is guided to a light receiver for self-diagnosis. In JP H10-31064 A, light emitted from the light emitter and traveling outside a scanning angle range is reflected off an inner surface of a translucent window plate installed at the front of the object detection device, to guide the reflected light to a light receiver for target detection or a light receiver for self-diagnosis. In JP 2002-31685 A, JP H09-318736 A, and JP H10-31064 A, upon self-diagnosis, a failure detector detects whether there is a failure in the light emitter or the light receiver, based on an electrical signal outputted from the light receiver.

Note that in JP 2010-204015 A and JP 2012-93256 A, in order to improve the detection accuracy of a distance from the object detection device to the target, the light guider provided in the object detection device guides light from the light emitter to the light receiver. Specifically, in JP 2010-204015 A, a light lead-in unit for an optical fiber is disposed on an optical axis of light that travels from the light emitter to the target side via the mirror of the rotating scanner, and the light is captured by the light lead-in unit to guide the light to the light receiver through the optical fiber. In addition, in JP 2012-93256 A, a reference reflector is disposed at an edge of a scanning range of light emitted from the light emitter, and the light is reflected off the reference reflector to guide the reflected light to the light receiver. In JP 2010-204015 A and JP 2012-93256 A, upon correction, etc., a correction value is calculated based on an electrical signal outputted from the light receiver, and the detected distance from the object detection device to the target is corrected using the correction value.

In the object detection device including the rotating scanner, when light for failure diagnosis is projected or received without passing through the rotating scanner, if a light projection path and a light reception path for failure diagnosis are provided in the object detection device totally separately from a light projection path and a light reception path for target detection, then the object detection device may increase in size. In addition, when light for target detection is projected through the rotating scanner but light for target detection is received without passing through the rotating scanner, too, a light reception path for target detection needs to be provided in the object detection device totally separately from a light projection path for target detection, and thus, the object detection device may increase in size. Furthermore, when a light emitter and a light receiver for failure diagnosis are provided separately from a light emitter and a light receiver for target detection, too, a light projection path and a light reception path for failure diagnosis need to be provided in the object detection device totally separately from a light projection path and a light reception path for target detection, and moreover, the number of components increases. Thus, the object detection device may further increase in size. In addition, the increase in the numbers of components of the light emitter and the light receiver increases the manufacturing cost of the object detection device.

### SUMMARY

An object of the disclosure is to self-diagnose whether there is a failure in an optical system in an object detection device including a rotating scanner, and to suppress an increase in the size of the object detection device.

An object detection device according to one or more embodiments of the disclosure includes a light emitter having a light emitting element; a light receiver having a light receiving element; a rotating scanner having a mirror and configured to reflect light from the light emitter off the mirror by rotating the mirror to scan the reflected light over a predetermined range, and to reflect light reflected off a target off the mirror to guide the reflected light to the light receiver, the target being present in the predetermined range; an object detector configured to detect whether there is a target, based on a light reception signal outputted from the light receiver; a light guider configured to guide light from the light emitter to the light receiver; and a failure detector configured to detect whether there is a failure, based on a light emission state of the light emitter and a light reception state, by the light receiver, of the light guided by the light guider. The light guider receives light emitted from the light emitter and reflected off the mirror, and reflects the light off the mirror to guide the reflected light to the light receiver.

According to the above description, upon failure detection, light from the light emitter is led into the light guider through the rotating scanner, and the light guider guides the light to the light receiver through the rotating scanner. In addition, upon target detection, light from the light emitter is projected over a scanning range for target detection through the rotating scanner, and the light receiver receives, through the rotating scanner, light reflected off a target present in the scanning range. Hence, the object detection device including the rotating scanner can self-diagnose whether there is a failure in an optical system such as the light emitter, the light receiver, and the rotating scanner, and can suppress an increase in the size of the object detection device by allowing a light projection path and a light reception path for target detection to partially overlap a light projection path and a light reception path for failure diagnosis. In addition, in target detection and optical system failure diagnosis, the light emitter and the light receiver are used in a shared manner. Thus, an increase in the number of components is prevented, by which an increase in the size of the object detection device can be further suppressed and an increase in the manufacturing cost of the object detection device can also be suppressed.

In one or more embodiments of the disclosure, the light guider may lead the received light to a different position than an irradiation position, on the mirror, of the light from the light emitter.

In addition, in one or more embodiments of the disclosure, the mirror may have a plurality of reflecting surfaces belonging to different planes, respectively.

In addition, in one or more embodiments of the disclosure, the light guider may receive light that is a part of the light emitted from the light emitter and reflected off the mirror and that travels outside a target detection range.

In addition, in one or more embodiments of the disclosure, the light guider may be disposed outside a range where light is scanned by the rotating scanner to detect the target.

In addition, in one or more embodiments of the disclosure, the light guider may be disposed on an opposite side of the mirror from the target.

In addition, in one or more embodiments of the disclosure, the light guider may project and receive the light onto and from a reflecting surface of the mirror facing an opposite side of the target.

Furthermore, in one or more embodiments of the disclosure, the light guider may be composed of a light guide having a lead-in surface into which light is led; and a lead-out surface from which the light is led.

According to one or more embodiments of the disclosure, an object detection device including a rotating scanner can self-diagnose whether there is a failure in an optical system, and an increase in the size of the object detection device can be suppressed.

### BRIEF DESCRIPTION OF THE DRAWINGS

FIG. 1 is an electrical configuration diagram of an object detection device according to one or more embodiments of the disclosure;

FIG. 2 is a perspective view of an external appearance of the object detection device of FIG. 1;

FIG. 3 is a perspective view of an internal structure of the object detection device according to a first embodiment;

FIG. 4 is a perspective view of the internal structure of FIG. 3 when viewed from another direction;

FIG. 5 is a top view of the internal structure of FIG. 3;

FIG. 6 is a top view showing the internal structure of FIG. 3 and a light scanning range;

FIG. 7 is a top view showing an internal structure of an object detection device according to a second embodiment of the disclosure and a light scanning range;

FIG. 8 is a top view showing an internal structure of an object detection device according to a third embodiment of the disclosure and a light scanning range; and

FIG. 9 is a top view showing an internal structure of an object detection device according to a fourth embodiment of the disclosure and a light scanning range.

### DETAILED DESCRIPTION

Embodiments of the disclosure will be described below with reference to the drawings. In the drawings, the same or corresponding portions are denoted by the same reference signs. In embodiments of the disclosure, numerous specific details are set forth in order to provide a more through understanding of the invention. However, it will be apparent to one of ordinary skill in the art that the invention may be practiced without these specific details. In other instances, well-known features have not been described in detail to avoid obscuring the invention

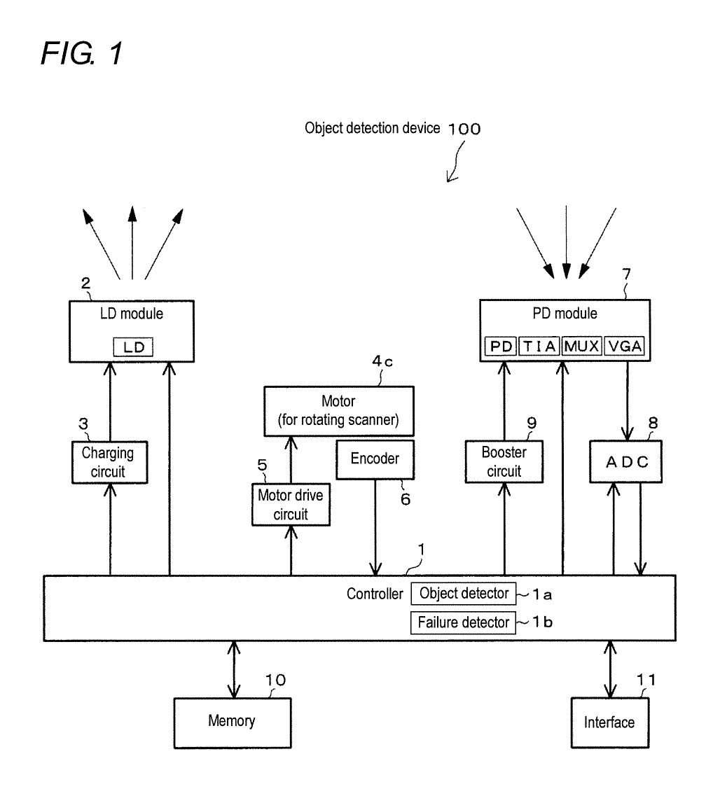

First, an electrical configuration of an object detection device 100 in one or more embodiments of the disclosure will be described with reference to FIG. 1.

FIG. 1 is an electrical configuration diagram of the object detection device 100. The object detection device 100 is a laser radar for vehicle mounting. A controller 1 is composed of a CPU, etc., and controls the operation of each unit of the object detection device 100. The controller 1 includes an object detector 1a and a failure detector 1b.

A laser diode (LD) module 2 is packaged. The LD module 2 includes a plurality of laser diodes (LDs) which are light sources (FIG. 1 only shows one LD block for convenience sake.). Each LD is a light emitting element that emits a high-power optical pulse. The LD module 2 is an example of a “light emitter” in one or more embodiments of the disclosure.

The controller 1 controls the operation of each LD in the LD module 2. Specifically, for example, the controller 1 allows each LD to emit light to project the light onto a target such as a person or an object. A charging circuit 3 is connected to the LD module 2. The controller 1 allows each LD to stop light emission to charge the LD by the charging circuit 3.

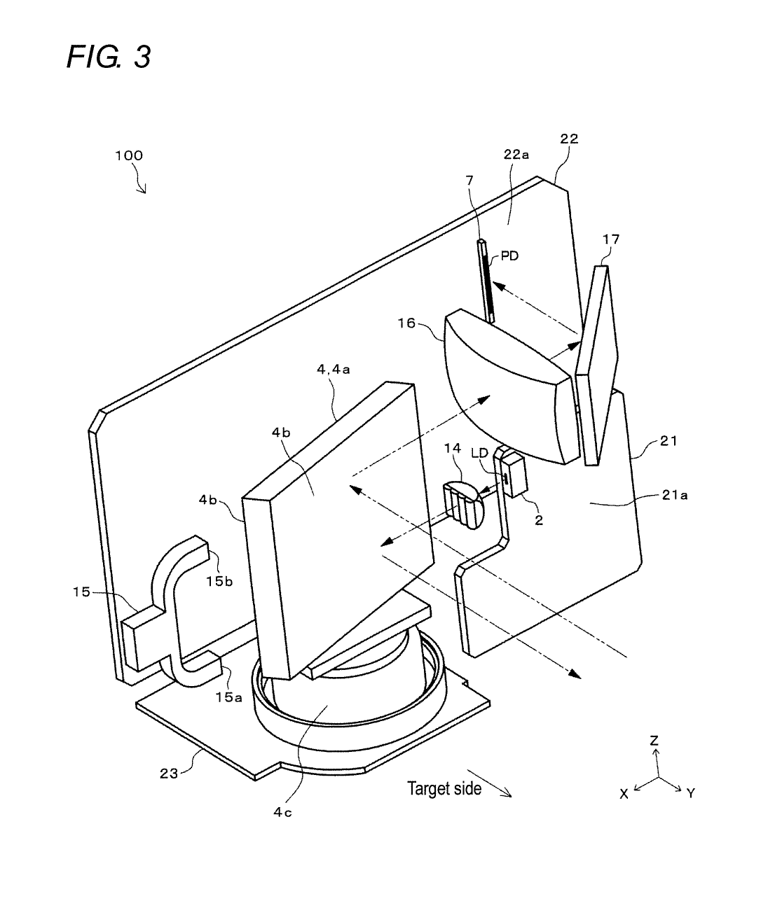

A motor 4c is a drive source for a rotating scanner 4 (FIG. 3, etc.) which will be described later. A motor drive circuit 5 drives the motor 4c. An encoder 6 detects a rotation state (an angle, the number of rotations, etc.) of the motor 4c. The controller 1 allows the motor drive circuit 5 to rotate the motor 4c to control the operation of the rotating scanner 4. In addition, the controller 1 detects an operating state (the amount of operation, an operating position, etc.) of the rotating scanner 4, based on an output from the encoder 6.

A photodiode (PD) module 7 is packaged. The PD module 7 includes PDs which are light receiving elements, a transimpedance amplifier (TIA), a multiplexer (MUX), and a variable gain amplifier (VGA) (detailed circuits are not shown). The PD module 7 is an example of a “light receiver” in one or more embodiments of the disclosure.

A plurality of PDs is provided in the PD module 7 (FIG. 1 only shows one PD block for convenience sake.). The MUX inputs an output signal from the TIA to the VGA. A booster circuit 9 supplies a boosted voltage which is required for the operation of the photodiodes, to each PD in the PD module 7. An analog-to-digital converter (ADC) 8 converts an analog signal outputted from the PD module 7 into a digital signal.

The controller 1 controls the operation of each unit of the PD module 7. Specifically, for example, the controller 1 allows the LDs in the LD module 2 to emit light, by which the PDs in the PD module 7 receive light reflected off a target. Then, the controller 1 allows the TIA and VGA in the PD module 7 to perform signal processing on a light reception signal which is outputted from the PDs according to a light reception state of the received light. Furthermore, the controller 1 allows the ADC 8 to convert the analog light reception signal outputted from the PD module 7 into a digital light reception signal. Based on the converted digital light reception signal, the object detector 1a in the controller 1 detects whether there is a target. In addition, the object detector 1a calculates a period of time from when the LDs emit light until the PDs receive light reflected off the target, and detects a distance from the object detection device 100 to the target, based on the period of time.

A memory 10 is composed of a volatile or nonvolatile memory. In the memory 10 are stored, for example, information for controlling each unit of the object detection device 100 by the controller 1 and information for detecting a target. An interface 11 is composed of a communication circuit for communicating with an electronic control unit (ECU) mounted on a vehicle. The controller 1 allows the interface 11 to transmit/receive information about a target or various types of control information to/from the ECU.

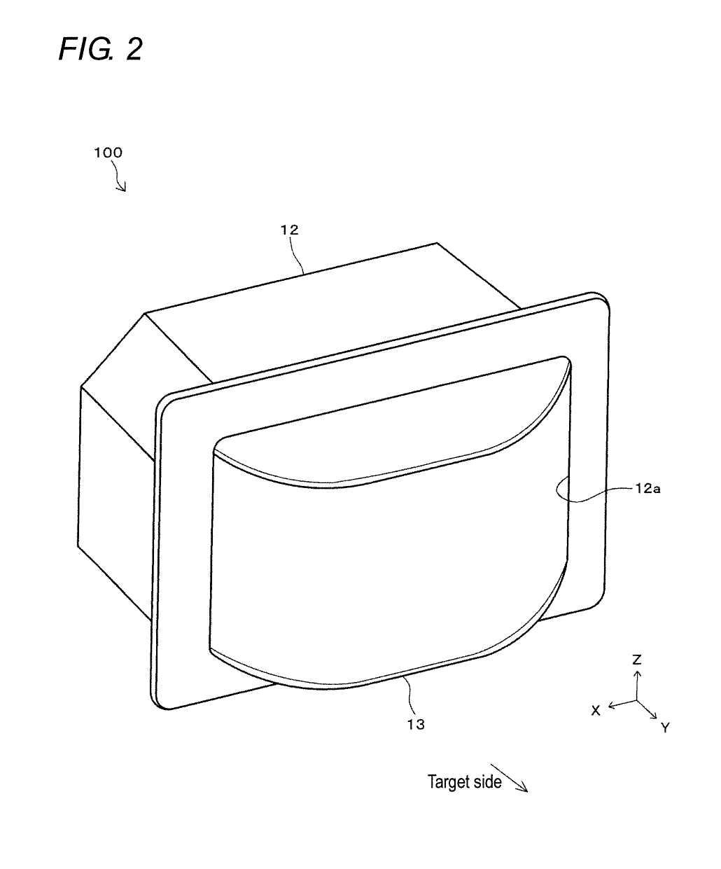

Next, the structure and function of the object detection device 100 will be described with reference to FIGS. 2 to 6.

FIG. 2 is a perspective view of an external appearance of the object detection device 100. Note that the external view of FIG. 2 and the configuration diagram of FIG. 1 are common for all of the following embodiments.

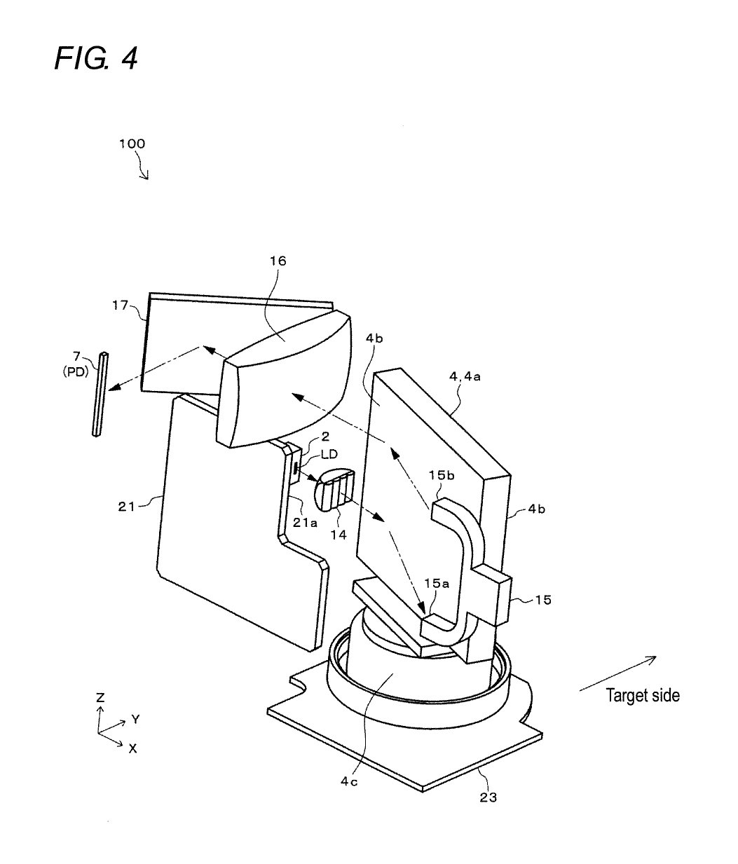

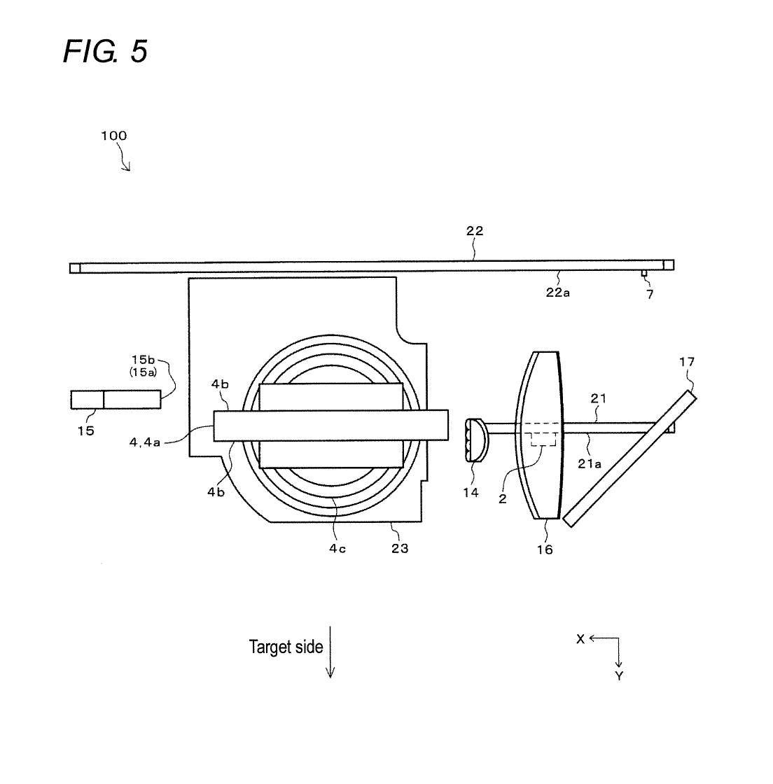

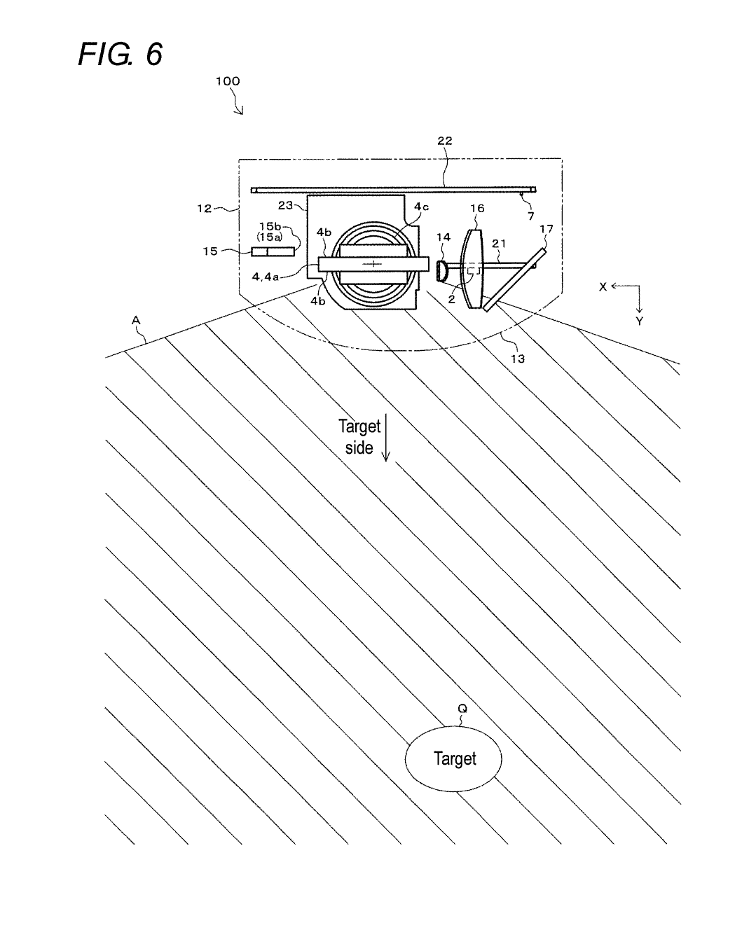

FIGS. 3 to 6 are diagrams showing an internal structure of the object detection device 100 according to a first embodiment. Specifically, FIGS. 3 and 4 are perspective views of the internal structure of the object detection device 100. FIG. 3 shows a state of the internal structure of the object detection device 100 when viewed from the target side. FIG. 4 shows a state of the internal structure of the object detection device 100 when viewed from the opposite side of a target. FIG. 5 is a top view of the internal structure of the object detection device 100. FIG. 6 is a top view showing the internal structure of the object detection device 100 and a light scanning range A.

As shown in FIG. 2, a case 12 of the object detection device 100 is a rectangular box as viewed from the front. An opening 12a of the case 12 is covered by a translucent cover 13. The translucent cover 13 is formed in a dome shape with a predetermined thickness.

An internal space enclosed by the case 12 and the translucent cover 13 accommodates an optical system such as that shown in FIGS. 3 to 6, an electrical system shown in FIG. 1, etc. The translucent cover 13 of FIG. 2 allows light to pass through the inside and outside of the case 12.

The object detection device 100 is installed, for example, at the front, rear, or left and right sides of a vehicle such that the translucent cover 13 faces in the forward, backward, or leftward and rightward directions of the vehicle. At that time, as shown in FIG. 2, the object detection device 100 is installed on the vehicle such that a short-side direction of the case 12 is oriented in an up-down direction Z.

The optical system of the object detection device 100 for detecting a target includes, as shown in FIG. 3, etc., the LDs in the LD module 2, a light projecting lens 14, the rotating scanner 4, a light receiving lens 16, a reflecting mirror 17, and the PDs in the PD module 7.

Of the above-described components, the LDs in the LD module 2, the light projecting lens 14, and the rotating scanner 4 form a light projecting optical system. In addition, the rotating scanner 4, the light receiving lens 16, the reflecting mirror 17, and the PDs in the PD module 7 form a light receiving optical system.

The LD module 2 is formed in a thin rectangular-parallelepiped form. As shown in FIG. 3, etc., the LD module 2 is mounted on an edge of one mounting surface 21a of a first substrate 21. The LD module 2 is disposed at a central portion of the object detection device 100. The first substrate 21 is fixed within the case 12 such that the mounting surface 21a faces the target side.

Each LD included in the LD module 2 faces the center side of the object detection device 100 and in a direction X parallel to the mounting surface 21a of the first substrate 21. Hence, each LD projects light mainly in the direction X parallel to the mounting surface 21a. Light emitted from each LD in the LD module 2 is not blocked by the first substrate 21.

The light projecting lens 14 is disposed on the light-emitting direction side of the LD module 2. The light projecting lens 14 adjusts the spread of light emitted from each LD in the LD module 2. The light projecting lens 14 is fixed within the case 12.

The PD module 7 is formed in a rectangular rod shape. The PD module 7 is mounted on one mounting surface 22a of a second substrate 22 such that its long side is parallel to the up-down direction Z. The second substrate 22 is fixed within the case 12 such that the mounting surface 22a faces the target side. In addition, the second substrate 22 is disposed on the opposite side of the first substrate 21 from a target. Note that FIG. 4 does not show the second substrate 22.

Each PD included in the PD module 7 faces the target side and in a direction Y perpendicular to the mounting surface 22a of the second substrate 22 (FIG. 3, etc.). Hence, each PD receives light coming mainly in a direction perpendicular to the mounting surface 22a (an anti-Y direction in FIG. 3, etc.).

The second substrate 22 is formed to be larger in size than the first substrate 21. On the first substrate 21 there is mounted a part of the charging circuit 3 shown in FIG. 1, in addition to the LD module 2. On the second substrate 22 there are mounted, for example, the ADC 8, the booster circuit 9, the other part of the charging circuit 3, the motor drive circuit 5, the controller 1, the memory 10, and the interface 11 which are shown in FIG. 1, in addition to the PD module 7. The first substrate 21 and the second substrate 22 are electrically connected to each other by connectors and flexible printed circuits (FPCs) which are not shown.

The light projecting lens 14, the rotating scanner 4, the light receiving lens 16, and the reflecting mirror 17 are disposed on the more target side than the second substrate 22.

The rotating scanner 4 is also called a rotating mirror or an optical deflector, and includes a mirror 4a, a motor 4c, etc. The mirror 4a is composed of a double-sided mirror formed in a plate form. Namely, both plate surfaces 4b of the mirror 4a are reflecting surfaces. The reflecting surfaces 4b belong to different planes, respectively.

The motor 4c is mounted on a third substrate 23. The third substrate 23 is fixed within the case 12 such that a rotating shaft (not shown) of the motor 4c is parallel to the Z direction.

A substrate surface of the third substrate 23 is perpendicular to the substrate surfaces of the first substrate 21 and the second substrate 22. The third substrate 23 and the second substrate 22 are electrically connected to each other by connectors and FPCs which are not shown.

The mirror 4a is connected to one end (an upper end in FIGS. 3 and 4) of the rotating shaft of the motor 4c. The mirror 4a rotates in conjunction with the rotating shaft of the motor 4c.

As shown in FIGS. 3 and 4, the light receiving lens 16 and the reflecting mirror 17 are disposed above the first substrate 21. The light receiving lens 16 is composed of a condenser lens. The light receiving lens 16 is fixed within the case 12 such that a light entering surface (convex surface) faces the rotating scanner 4.

The reflecting mirror 17 is disposed on the opposite side of the light receiving lens 16 from the rotating scanner 4. The reflecting mirror 17 is fixed within the case 12 so as to be inclined at a predetermined angle with respect to the light receiving lens 16 and the light receiving portions of the PDs in the PD module 7.

As indicated by a dashed-dotted-line arrow in FIG. 3, light emitted from the LDs in the LD module 2 is adjusted its spread by the light projecting lens 14 and then hits a lower half portion of either reflecting surface 4b of the mirror 4a of the rotating scanner 4. At this time, the motor 4c rotates and the angle (orientation) of the mirror 4a changes, by which either reflecting surface 4b faces the target side. By this, after the light from the LDs passes through the light projecting lens 14, the light is reflected off the lower half portion of the reflecting surface 4b, and the reflected light passes through the translucent cover 13 (FIG. 2) and is scanned over a predetermined range outside. That is, the rotating scanner 4 deflects the light from the LDs in the LD module 2 to the target side of the first substrate 21.

Note that a hatched range A of FIG. 6 is a scanning range of light that is projected for target detection by the object detection device 100 (viewed from the top) (FIG. 6 shows a portion of the light scanning range A for target detection near the object detection device 100.). A portion of the light scanning range A outside the case 12 and the translucent cover 13 is a detection range for a target Q by the object detection device 100.

The projected light having passed through the translucent cover 13 in the manner described above is reflected off the target Q such as a person or an object. The reflected light passes through the translucent cover 13 and then, as indicated by a dashed-double-dotted-line arrow in FIG. 3, the reflected light hits an upper half portion of either reflecting surface 4b of the mirror 4a of the rotating scanner 4. That is, the irradiation position, on the reflecting surface 4b of the mirror 4a, of the reflected light from the target Q differs from the irradiation position, on the reflecting surface 4b of the mirror 4a, of the light from the LDs in the LD module 2. At this time, the motor 4c rotates and the angle (orientation) of the reflecting surfaces 4b of the mirror 4a changes, by which either reflecting surface 4b faces the target side. By this, after the light reflected off the target Q passes through the translucent cover 13, the reflected light is reflected off the upper half portion of the reflecting surface 4b and enters the light receiving lens 16. That is, the rotating scanner 4 deflects the reflected light from the target Q to the light receiving lens 16 side.

The reflected light having entered the light receiving lens 16 via the rotating scanner 4 is collected by the light receiving lens 16 and is then reflected off the reflecting mirror 17 and received by the PDs in the PD module 7. That is, the reflecting mirror 17 reflects the reflected light that is deflected by the rotating scanner 4, to the PD module 7 side. In addition, the rotating scanner 4 reflects the reflected light from the target Q off the mirror 4a to guide the reflected light to the PDs in the PD module 7 through the light receiving lens 16 and the reflecting mirror 17.

A light reception signal outputted from the PDs according to a light reception state of the above-described reflected light is subjected to signal processing by the PD module 7 and the ADC 8. Then, based on the processed light reception signal, the object detector 1a in the controller 1 detects whether there is a target Q, and calculates a distance from the object detection device 100 to the target Q.

As shown in FIGS. 3 to 6, a light guide 15 is also provided within the case 12 of the object detection device 100. The light guide 15 is formed of a material with light-guiding properties. The light guide 15 is a member that guides light for diagnosing a failure in the optical system. The light guide 15 guides light emitted from the LDs in the LD module 2, to the PDs in the PD module 7. The light guide 15 is an example of a “light guider” in one or more embodiments of the disclosure.

As shown in FIGS. 3, 5, etc., the light guide 15 is disposed on the opposite side of the mirror 4a of the rotating scanner 4 from the LD module 2, the PD module 7, the light projecting lens 14, the light receiving lens 16, and the reflecting mirror 17. In addition, as shown in FIGS. 5, 6, etc., the light guide 15 is disposed on the opposite side of the mirror 4a from the target. Furthermore, the light guide 15 is disposed outside the light scanning range A for target detection.

As shown in FIGS. 3 and 4, the light guide 15 has a lead-in surface 15a into which light is led; and a lead-out surface 15b from which the light is led. The light guide 15 is fixed within the case 12 such that the lead-in surface 15a and the lead-out surface 15b face the mirror 4a side of the rotating scanner 4 and in a direction parallel to the first and second substrates 21 and 22 (an anti-X direction in FIGS. 3 and 4). The lead-in surface 15a and the lead-out surface 15b are placed side by side in the up-down direction Z. The lead-out surface 15b is disposed in a higher position than the lead-in surface 15a.

As indicated by a dashed-dotted-line arrow in FIG. 4, light emitted from the LDs in the LD module 2 is adjusted its spread by the light projecting lens 14 and then hits a lower half portion of either reflecting surface 4b of the mirror 4a of the rotating scanner 4. At this time, the motor 4c rotates and the angle of the mirror 4a changes, by which either reflecting surface 4b faces the opposite side of a target. By this, after the light from the LDs passes through the light projecting lens 14, the light is reflected off the lower half portion of the reflecting surface 4b, and the reflected light enters the lead-in surface 15a of the light guide 15. That is, the light guide 15 receives the light from a reflecting surface 4b on the opposite side of the target. To put it another way, the light guide 15 receives light that is a part of the light emitted from the LDs and reflected off the mirror 4a and that travels outside the target detection range (the scanning range A of FIG. 6).

Then, the light having been led into the lead-in surface 15a travels inside the light guide 15, and as indicated by a dashed-double-dotted-line arrow in FIG. 4, the light is led from the lead-out surface 15b of the light guide 15 and hits an upper half portion of either reflecting surface 4b of the mirror 4a of the rotating scanner 4. That is, the light guide 15 leads the light to a different position than an irradiation position, on the reflecting surface 4b of the mirror 4a, of the light from the LDs. At this time, the motor 4c rotates and the angle of the mirror 4a changes, by which either reflecting surface 4b faces the opposite side of the target. By this, the light exiting from the light guide 15 is reflected off the upper half portion of the reflecting surface 4b and enters the light receiving lens 16. That is, the light guide 15 projects the light onto a reflecting surface 4b of the mirror 4a facing the opposite side of the target.

The light having entered the light receiving lens 16 from the light guide 15 via the rotating scanner 4 is collected by the light receiving lens 16, and is then reflected off the reflecting mirror 17 and received by the PDs in the PD module 7. As described above, the light guide 15 receives light that is emitted from the LDs and reflected off the mirror 4a, and reflects the light off the mirror 4a to guide the reflected light to the PDs.

A light reception signal outputted from the PDs according to a light reception state of the light guided by the light guide 15 is subjected to signal processing by the PD module 7 and the ADC 8. Then, based on the processed light reception signal and the light emission state of the LDs, the failure detector 1b in the controller 1 detects whether there is a failure in the optical system such as the LD module 2, the PD module 7, and the rotating scanner 4. When a light reception signal is not outputted normally despite the fact that the LDs emit light, the failure detector 1b determines that the optical system has a failure.

The light projection and reception paths for object detection shown in FIG. 3 partially overlap the light projection and reception paths for failure detection shown in FIG. 4. Specifically, the optical paths from the LDs to the rotating scanner 4 for object detection and for failure detection substantially coincide with each other, and the optical paths from the rotating scanner 4 to the PDs for object detection and for failure detection also substantially coincide with each other. In addition, the light projection and reception paths for object detection and the light projection and reception paths for failure detection are common in that the paths start from the LDs and reach the PDs via the light projecting lens 14, the rotating scanner 4, the light receiving lens 16, and the reflecting mirror 17.

According to the first embodiment, upon detection of a failure in the optical system, light from the LDs in the LD module 2 is led into the light guide 15 through the rotating scanner 4, and the light guide 15 guides the light to the PDs in the PD module 7 through the rotating scanner 4. In addition, upon target detection, light from the LDs is projected over a scanning range A for target detection through the rotating scanner 4, and the PDs receive light reflected off a target Q present in the scanning range A through the rotating scanner 4. Hence, the object detection device 100 including the rotating scanner 4 can self-diagnose whether there is a failure in the optical system, and an increase in the size of the object detection device 100 can be suppressed by allowing a light projection path and a light reception path for target detection to partially overlap a light projection path and a light reception path for failure diagnosis. In addition, in target detection and optical system failure diagnosis, the LDs in the LD module 2 and the PDs in the PD module 7 are used in a shared manner.

Hence, an increase in the number of components is prevented, by which an increase in the size of the object detection device 100 can be further suppressed and an increase in the manufacturing cost of the object detection device 100 can also be suppressed.

In addition, in the first embodiment, the light guide 15 leads light to a different position than an irradiation position, on the mirror 4a of the rotating scanner 4, of light from the LDs, and irradiates the light to the different position. Hence, the light projection path and light reception path for failure diagnosis can be separated from each other on the rotating scanner 4. Interference is suppressed between light that is emitted from the LDs and reaches the light guide 15 through the rotating scanner 4 and light that comes out of the light guide 15 and reaches the PDs through the rotating scanner 4. Accordingly, the detection accuracy of failure diagnosis can be improved.

In addition, in the first embodiment, the mirror 4a of the rotating scanner 4 has the plurality of reflecting surfaces 4b belonging to different planes, respectively. Hence, the numbers of light projections and receptions per unit time for light for target detection and light for failure diagnosis each are increased, being able to improve the detection accuracy of target detection and failure diagnosis.

In addition, in the first embodiment, the light guide 15 is disposed outside the range A where light is scanned by the rotating scanner 4 to detect a target. The light guide 15 receives light that is a part of light emitted from the LDs and reflected off the mirror 4a of the rotating scanner 4 and that travels outside the target detection range. Hence, the scanning range of light projected for target detection can be prevented from becoming narrow.

In addition, in the first embodiment, the light guide 15 is disposed on the opposite side of the mirror 4a of the rotating scanner 4 from a target. The light guide 15 projects and receives light onto/from a reflecting surface 4b of the mirror 4a facing the opposite side of the target. Hence, an optical path of light for failure detection is formed on the opposite side of the mirror 4a from the target, being able to more securely prevent the scanning range of light projected for target detection from becoming narrow.

Furthermore, in the first embodiment, the light guide 15 is used as a light guider for failure detection. Hence, light emitted from the LDs and reflected off the mirror 4a of the rotating scanner 4 can be led into the light guide 15 through the lead-in surface 15a of the light guide 15, led out through the lead-out surface 15b, reflected off the mirror 4a of the rotating scanner 4, and securely guided to the PDs.

The disclosure can also adopt various embodiments other than that described above. For example, although the first embodiment shows an example in which the mirror 4a of the rotating scanner 4 is composed of a thin plate-like double-sided mirror having two reflecting surfaces 4b, the disclosure is not limited thereto.

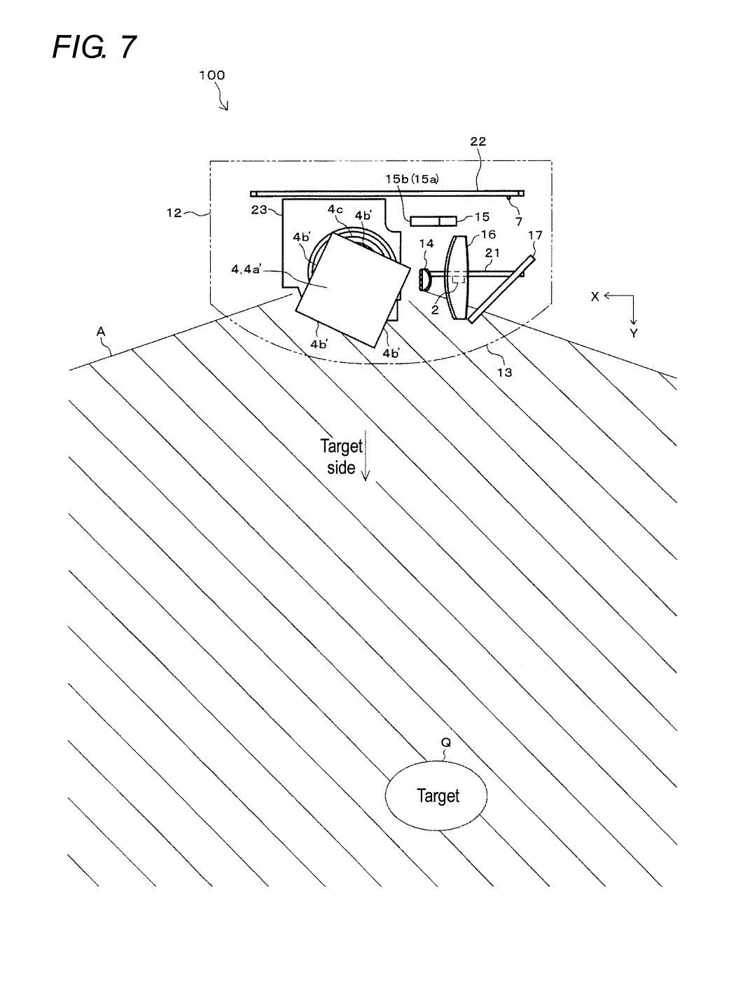

As another example, for example, as in a second embodiment shown in FIG. 7, a mirror 4a′ of a rotating scanner 4 may be composed of a rectangular-parallelepiped mirror having four reflecting surfaces 4b′. The reflecting surfaces 4b′ belong to different planes, respectively, which are parallel to the up-down direction Z. In addition, a mirror having any other shape and having one or more reflecting surfaces may be used as the mirror of the rotating scanner.

In addition, although the first embodiment shows an example in which the light guide 15 is disposed on the opposite side of the mirror 4a of the rotating scanner 4 from the LD module 2, etc., and on the opposite side of the mirror 4a of the rotating scanner 4 from a target, the disclosure is not limited thereto.

As another example, for example, as in the second embodiment shown in FIG. 7, the light guide 15 may be disposed on the LD module 2 side from the mirror 4a′ and on the opposite side of the mirror 4a′ from a target. The light guide 15 of the second embodiment is specifically disposed between the light projecting lens 14 and the light receiving lens 16, and the second substrate 22 as viewed from the target Q side.

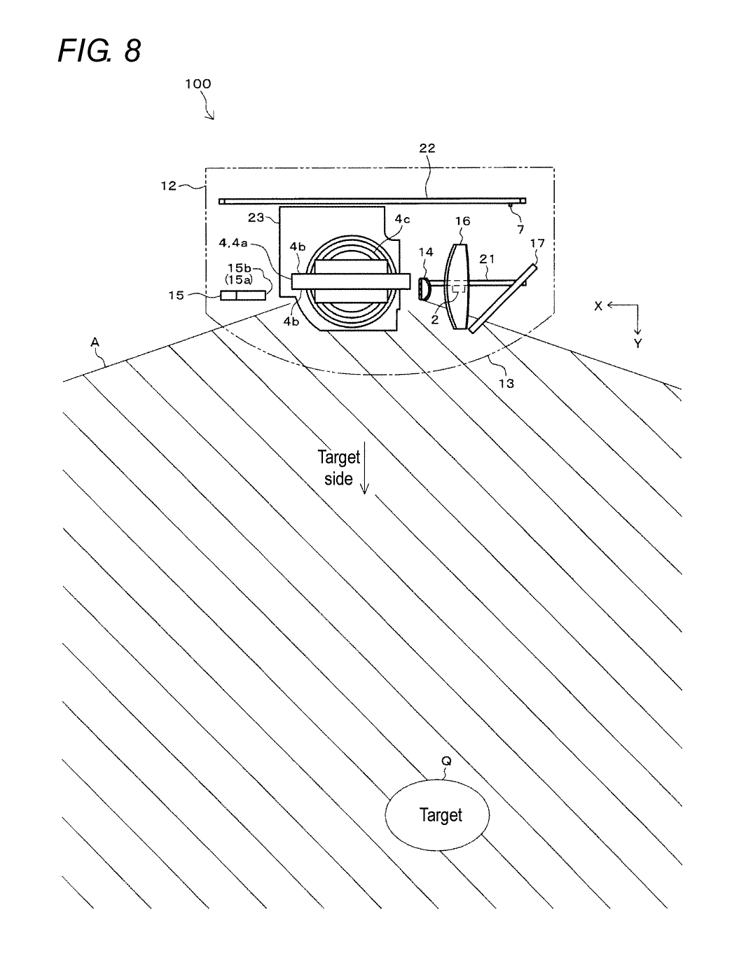

In addition, as in a third embodiment shown in FIG. 8, the light guide 15 may be disposed on the opposite side of the mirror 4a from the LD module 2, etc., and on the target side from the mirror 4a.

In the case of the second and third embodiments, the light guide 15 is installed such that the lead-in surface 15a and lead-out surface 15b of the light guide 15 face the mirror 4a, 4a′. In addition, the lead-out surface 15b is positioned above the lead-in surface 15a.

In the second and third embodiments, the light guide 15 is disposed outside the range A where light is scanned by the rotating scanner 4 to detect a target. The light guide 15 receives light that is a part of light emitted from the LDs and reflected off the mirror 4a, 4a′ and that travels outside the target detection range. Hence, the light guide 15 does not narrow the scanning range A of light projected for target detection.

Even if the light guide 15 is disposed in the manner shown in the second and third embodiments, upon target and failure detection, light can be projected and received from the LDs to the PDs via the rotating scanner 4. Hence, whether there is a failure in the optical system can be self-diagnosed, and an increase in the size of the object detection device 100 can be suppressed.

In addition, in the second embodiment of FIG. 7, the light guide 15 is disposed on the opposite side of the mirror 4a′ from the target. The light guide 15 projects and receives light onto/from a reflecting surface 4b′ of the mirror 4a′ facing the opposite side of the target. Hence, an optical path of light for failure detection is formed on the opposite side of the mirror 4a′ from the target, being able to prevent the scanning range A of light projected for target detection from becoming narrow.

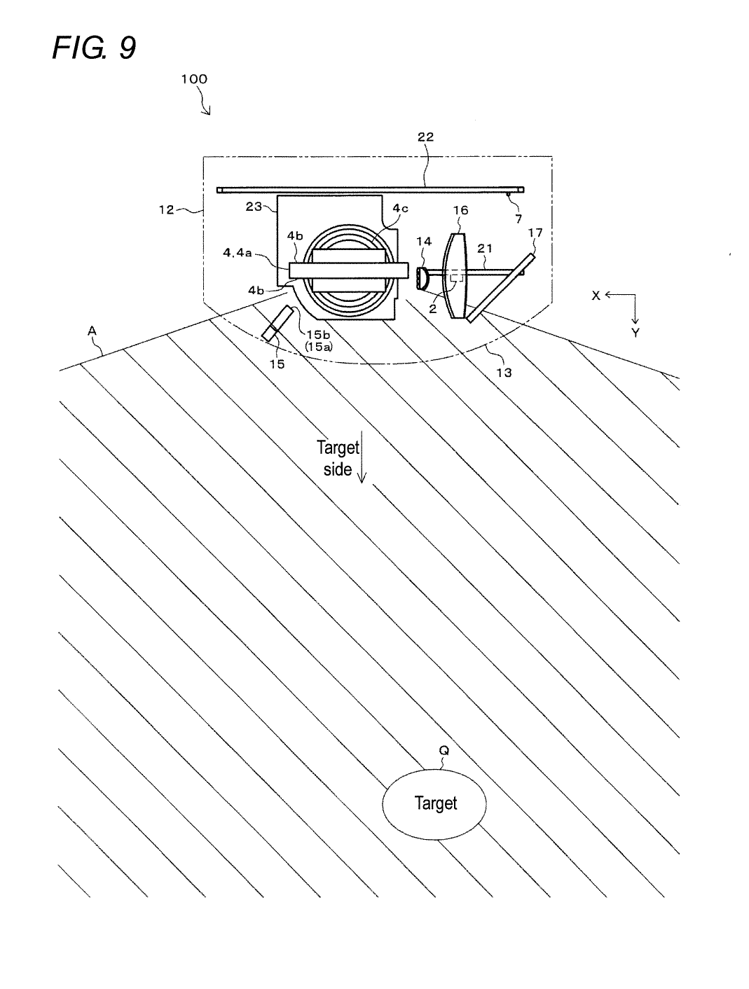

In addition, as in a fourth embodiment shown in FIG. 9, the light guide 15 may be disposed in the range A where light is scanned by the rotating scanner 4 to detect the target Q. Specifically, the light guide 15 of the fourth embodiment is disposed at an edge of the scanning range A that is on the opposite side of the mirror 4a from the LD module 2, etc. In this case, too, the light guide 15 is installed such that the lead-in surface 15a and lead-out surface 15b of the light guide 15 face the mirror 4a. In addition, the lead-out surface 15b is positioned above the lead-in surface 15a. The light guide 15 projects and receives light onto/from a reflecting surface 4b of the mirror 4a facing the target side. By doing this, too, upon target and failure detection, light can be projected and received from the LDs to the PDs via the rotating scanner 4. Hence, whether there is a failure in the optical system can be self-diagnosed, and an increase in the size of the object detection device 100 can be suppressed.

In addition, illustrative embodiments show an example in which the light guide 15 projects and receives light to/from the PDs and the LDs via the rotating scanner 4, and the failure detector 1b detects whether there is a failure in the optical system, based on the light emission state of the LDs and the light reception state of the PDs obtained at that time; however, the disclosure is not limited thereto. For example, in a case in which the light guide 15 is disposed in a position shown in FIG. 6 or 8, when the mirror 4a is in parallel to the first and second substrates 21 and 22, the light guide 15 can also project and receive light to/from the PDs and the LDs without going through the rotating scanner 4. Hence, the failure detector 1b may detect whether there is a failure in the optical system, based on the light emission state of the LDs and the light reception state of the PDs which are obtained when the light guide 15 projects and receives light to/from the PDs and the LDs via the rotating scanner 4 and based on the light emission state of the LDs and the light reception state of the PDs which are obtained when the light guide 15 projects and receives light to/from the PDs and the LDs without going through the rotating scanner 4.

In addition, although illustrative embodiments show an example in which the light guider is composed of the light guide 15, the disclosure is not limited thereto. In addition to this, a member capable of receiving light and projecting the light in a specific direction, e.g., a mirror, a reflector, or an optical fiber, may be used as the light guider.

In addition, although illustrative embodiments show an example in which one LD module 2 having a plurality of LDs and one PD module 7 having a plurality of PDs are provided, the disclosure is not limited thereto. The numbers of LD modules and PD modules installed may be two or more. In addition, the numbers of LDs and PDs in the LD module 2 and the PD module 7 may be selected as appropriate.

In addition, although illustrative embodiments show an example in which the light reception path of light is provided above the light projection path of light, the disclosure is not limited thereto. In addition to this, the light reception path of light may be provided beneath the light projection path of light.

Furthermore, although illustrative embodiments describe an example in which the disclosure is applied to the object detection device 100 for vehicle mounting, the disclosure can also be applied to object detection devices for other applications.

While the invention has been described with reference to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. An object detection device comprising:
a light emitter having a light emitting element;
a light receiver having a light receiving element;
a rotating scanner having a mirror and configured to reflect light from the light emitter off the mirror by rotating the mirror to scan the reflected light over a predetermined range, and to reflect light reflected off a target off the mirror to guide the reflected light to the light receiver, the target being present in the predetermined range;
an object detector configured to detect whether there is a target, based on a light reception signal outputted from the light receiver;
a light guider configured to guide light from the light emitter to the light receiver; and
a failure detector configured to detect whether there is a failure, based on a light emission state of the light emitter and a light reception state, by the light receiver, of the light guided by the light guider,
wherein the light guider receives light emitted from the light emitter and reflected off the mirror, and reflects the light off the mirror to guide the reflected light to the light receiver.

2. The object detection device according to claim 1, wherein the light guider leads the received light to a different position than an irradiation position, on the mirror, of the light from the light emitter.

3. The object detection device according to claim 1, wherein the mirror has a plurality of reflecting surfaces belonging to different planes, respectively.

4. The object detection device according to claim 1, wherein the light guider receives light that is a part of the light emitted from the light emitter and reflected off the mirror and that travels outside a target detection range.

5. The object detection device according to claim 1, wherein the light guider is disposed outside a range where light is scanned by the rotating scanner to detect the target.

6. The object detection device according to claim 1, wherein the light guider is disposed on an opposite side of the mirror from the target.

7. The object detection device according to claim 1, wherein the light guider projects and receives the light onto and from a reflecting surface of the mirror facing an opposite side of the target.

8. The object detection device according to claim 1, wherein the light guider is composed of a light guide having a lead-in surface into which light is led; and a lead-out surface from which the light is led.
